(19) United States
(12) Patent Application Publication
(10) Pub. No.: US 2003/0161662 A1
(43) Pub. Date: Aug. 28, 2003

(54) Photosensitive drum structure for image forming apparatus using photosensitive belt

(75) Inventors: Yong-Geun Kim, Gyeonggi-do (KR); Lee Jin Soo, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS, INC., Suwon-city (KR)

(21) Appl. No.: 10/197,507

(22) Filed: Jul. 18, 2002

(30) Foreign Application Priority Data
Feb. 26, 2002 (KR) 2002-10262

(51) Int. Cl. G03G 15/00

(52) U.S. Cl. 399/162

(57) ABSTRACT

A photosensitive drum structure for an image forming apparatus using a photosensitive belt. The photosensitive drum structure includes a rotary drum, and a photosensitive belt which is wound on the rotary drum by an adhesive. Here, both ends of the photosensitive belt are overlapped to form a joint on the rotary drum. An inexpensive photosensitive belt is wound on the rotary drum. Thus, the photosensitive drum can be manufactured at a low cost. A joint contacts a cleaning blade at a point and a coating is formed to coat an exposed step of the joint to considerably reduce shocks between the joint and the cleaning blade, thereby prolonging the life of the photosensitive drum and the cleaning blade.

### CROSS-REFERENCE TO RELATED APPLICATIONS

This application claims the benefit of Korean Application No. 2002-10262, filed Feb. 26, 2002, in the Korean Industrial Property Office, the disclosure of which is incorporated herein by reference.

### BACKGROUND OF THE INVENTION

1. Field of the Invention

The present invention relates to a photosensitive drum structure for an image forming apparatus using a photosensitive belt.

2. Description of the Related Art

In general, an electrophotographic printer such as a laser printer forms a latent electrostatic image on a photosensitive medium, develops the latent electrostatic image with a toner having a predetermined color, and transfers the developed toner image to a printing paper in order to obtain a desired image. The photosensitive medium is typically a photosensitive belt or a photosensitive drum.

FIG. 1 is a view of a portion of an image forming apparatus using a typical photosensitive belt as a photosensitive medium. Referring to FIG. 1, the rotation path of a photosensitive belt 10 that travels a continuous path due to rollers 10a, 10b, and 10c includes an eraser 12, a charger 14, a laser scanning unit (LSU) 16, and a plurality of developing units 18a, 18b, 18c, and 18d. The eraser 12 erases charges on the photosensitive belt 10. The charger 14 charges the photosensitive belt 10 with a predetermined electric potential. The LSU 16 radiates light onto the photosensitive belt 10 to form a latent electrostatic image. The plurality of developing units 18a, 18b, 18c, and 18d, which are disposed in series along the travel direction of the photosensitive belt 10, each develop the latent electrostatic image as a toner image with a different color. The developed toner image is transferred to a transfer belt 20 that circulates in contact with the photosensitive belt 10.

However, in the above-described transfer method, the photosensitive belt 10 may move laterally outside of a transfer range of an image. Thus, a steering unit (not shown) is needed to adjust the photosensitive belt 10.

FIG. 2 is a view of a portion of an image forming apparatus using a photosensitive drum as a photosensitive medium to solve the problems caused by the use of a photosensitive belt. Elements that are the same as those in FIG. 1 are described with the same numerals, and thus their detailed descriptions are omitted.

Referring to FIG. 2, instead of the photosensitive belt 10 of FIG. 1, a large-sized photosensitive drum 30 is used and a steering unit is not required. However, a different problem occurs in the manufacture of the photosensitive drum 30. When the photosensitive drum 30 having a diameter of 25-32 mm is manufactured, a rotary drum having a diameter of 25-32 mm is dipped in a container containing a photosensitive solution to form a photosensitive film. In this case, a plurality of small-sized cylinders are manufactured at the same time, and thus manufacturing costs are low. However, since the photosensitive drum 30 uses a large-sized rotary drum having a diameter of about 150 mm, it is difficult to dip multiple drums in the container containing the photosensitive solution. Also, it is expensive to manufacture the photosensitive drum.

### SUMMARY OF THE INVENTION

Accordingly, it is an object of the present invention to provide a photosensitive drum structure for an image forming apparatus in which a photosensitive belt is adhered on a rotary drum to form a stable joint on the photosensitive drum.

Additional objects and advantages of the invention will be set forth in part in the description which follows and, in part, will be obvious from the description, or may be learned by practice of the invention.

The foregoing and other objects of the present invention are achieved by providing a photosensitive drum structure for an image forming apparatus using a photosensitive belt, the photosensitive drum structure including a rotary drum; and a photosensitive belt wound on the rotary drum and attached by an adhesive, wherein both ends of the photosensitive belt are overlapped to form a joint on the rotary drum.

According to an aspect of the present invention, a coating to cover an exposed step of the joint is formed.

According to another aspect of the present invention, the joint contacts a cleaning blade at a point which is positioned in a longitudinal direction of the photosensitive drum.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a view of a portion of an image forming apparatus using a conventional photosensitive belt;

FIG. 2 is a view of a portion of an image forming apparatus using a conventional photosensitive drum;

FIG. 3 is a schematic view of a printer adopting a photosensitive drum according to the present invention;

FIG. 4 is a plan view of a portion of a photosensitive drum used in the image forming apparatus shown in FIG. 3 according to a first embodiment of the present invention;

FIG. 5 is a cross-sectional view taken along line V-V′ of FIG. 4;

FIG. 6 is a plan view of a portion of a photosensitive drum according to a second embodiment of the present invention;

FIG. 7 is a cross-sectional view taken along line VII-VII of FIG. 6;

FIG. 8 is a plan view of a portion of a photosensitive drum on which a joint is formed, according to a third embodiment of the present invention; and

FIG. 9 is a plan view of a portion of a photosensitive drum on which a joint is formed, according to a fourth embodiment of the present invention.

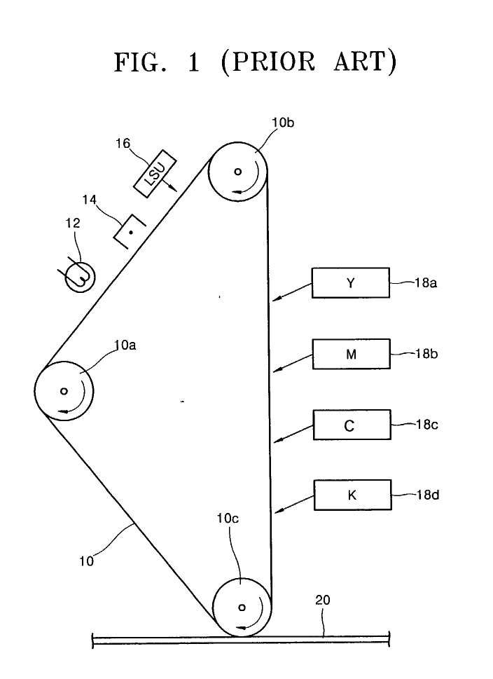

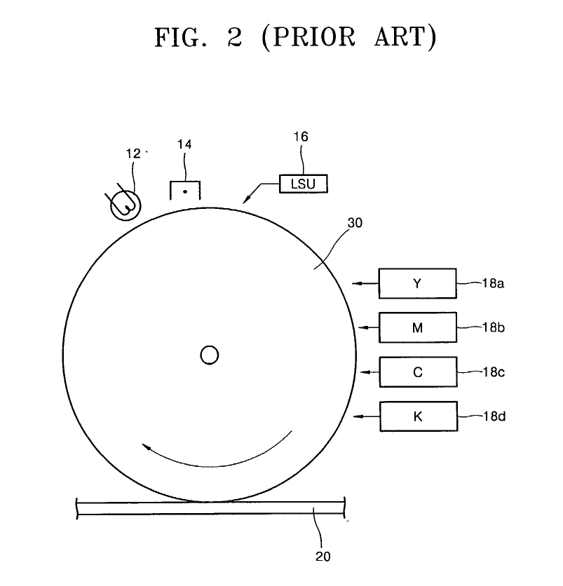

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout. In the drawings, the thicknesses of layers or regions are exaggerated for clarity.

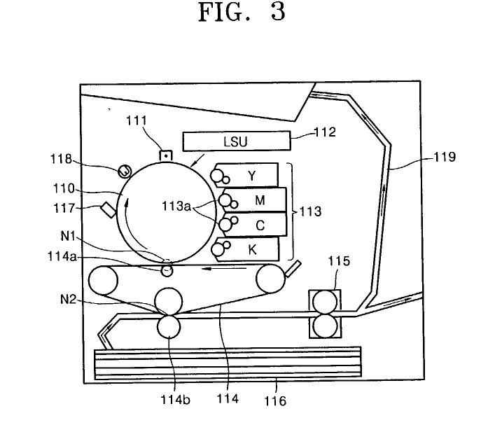

FIG. 3 is a schematic view of a printer adopting a photosensitive drum according to the present invention. Referring to FIG. 3, the electrophotographic color image forming apparatus includes a photosensitive drum 110, a charger 111, a laser scanning unit (LSU) 112, developing units 113, a transfer belt 114, a first transfer roller 114a, a second transfer roller 114b, and a fixing unit 115. The photosensitive drum 110 is a photosensitive body. The charger 114 charges the photosensitive drum 110 with a predetermined electric potential. The LSU 112 radiates light onto the charged photosensitive drum 110 to form a predetermined latent electrostatic image. The developing units 113 develop the latent electrostatic image with toners each having a different color, i.e., yellow Y, magenta M, cyan C, and black K. The first transfer roller 114a transfers the image that is developed on the photosensitive drum 110 to the transfer belt 114. The second transfer roller 114b transfers the four color images that are overlapped on the transfer belt 114 to a paper. The fixing unit 115 hot-presses the paper to permanently fix the transferred images on the paper. The developing units 113 include four developing units 113-Y, 113-M, 113-C, and 113-K, each of which is spaced apart from the photosensitive drum 110. Each developing unit 113 sequentially moves toward the photosensitive drum 110 by way of a contact unit (not shown) so that a developing roller 113a at the respective tips of the developing units 113 contacts the photosensitive drum 110. Reference numerals 116, 117, 118, and 119 represent a paper cassette, a cleaning blade to clean the photosensitive drum 110, an eraser, and a transfer path to discharge papers, respectively.

A process of forming an image in the color image forming apparatus shown in FIG. 3 will now be described. The charger 111 charges the photosensitive drum 110 with a predetermined electric potential. The LSU 116 radiates light onto the photosensitive drum 110 to form a latent electrostatic image that will be developed with a first color at a predetermined area of the photosensitive drum 110. For example, if the first color is yellow, the yellow developing unit 113-Y contacts the photosensitive drum 110 by means of the contact unit. Thus, a toner that is attached to the circumferential surface of the developer roller 113a-Y is moved to the latent electrostatic image on the photosensitive drum 110 that contacts the circumferential surface of the developer roller 113a-Y. The developed yellow image on the photosensitive drum 110 is transferred to the transfer belt 114 through a first transfer nip N1 between the photosensitive drum 110 and the first transfer roller 114a. Next, the photosensitive drum 110 is charged and exposed to form a latent electrostatic image for magenta. This image is developed by the developing unit 113-M to form the magenta image. The developed magenta image on the photosensitive drum 110 is transferred to the transfer belt 114 through the first transfer nip N1. After cyan and black images are formed on the transfer belt 114 by the same method, the overlapped color images are transferred to a paper which is supplied to a second transfer nip N2 between the transfer belt 114 and the second transfer roller 114b. Thereafter, the transferred images on the paper are hot-pressed when passing through the fixing unit 115 to be permanently fixed on the paper.

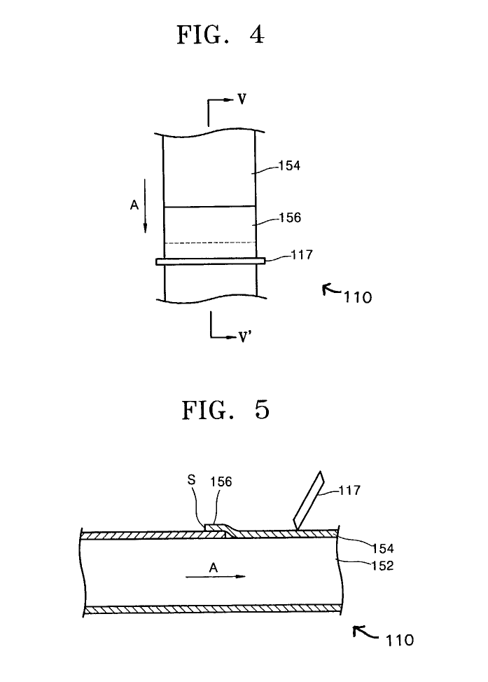

FIG. 4 is a plan view of a portion of the photosensitive drum 110 used in the color image forming apparatus shown in FIG. 3, according to a first embodiment of the present invention. FIG. 5 is a cross-sectional view taken along line V-V′. Referring to FIGS. 4 and 5, a photosensitive belt 154 is attached on the circumferential surface of a cylindrical rotary drum 152 made of aluminium or an aluminium alloy. The photosensitive belt 154 is formed of a sequential stack of a base layer, a conductive layer, and a photosensitive layer. When a laser is radiated onto the surface of the photosensitive belt 154, electrons of the photosensitive layer pass through the conductive layer to the outside, which results in formation of the latent electrostatic image. The photosensitive belt 154 used in this embodiment of the present invention has a thickness of 50 μm. When the photosensitive belt 154 is wound on the rotary drum 152 by an adhesive, both ends of the photosensitive belt 154 are overlapped to form a joint 156. The joint 156 has a uniform width on the photosensitive drum 110, as shown in FIGS. 4 and 5. A dotted line indicates an end of the photosensitive belt 154 hidden under the joint 156, and a solid line indicates the other end of the photosensitive belt 154 which is exposed. Also, the solid line represents a step S having the same thickness as the photosensitive belt 154. Here, reference character A denotes a rotating direction of the photosensitive drum 110, which rotates so that the hidden end (dotted line) of the joint 156 first meets a cleaning blade 117. The joint 156 contacts the cleaning blade 117 to clean toner remaining on the photosensitive drum 110 when the photosensitive drum 110 is used in the color image forming apparatus shown in FIG. 3. Here, as shown in FIG. 4, when the joint 156 contacts the cleaning blade 117, the cleaning blade 117 first contacts the dotted line and then the step S indicated by the solid line, between the cleaning blade 117 that is fixed, and the photosensitive drum 110 which is rotating in the direction A. Thus, shocks caused by contact between the joint 156 and the cleaning blade 117 are absorbed.

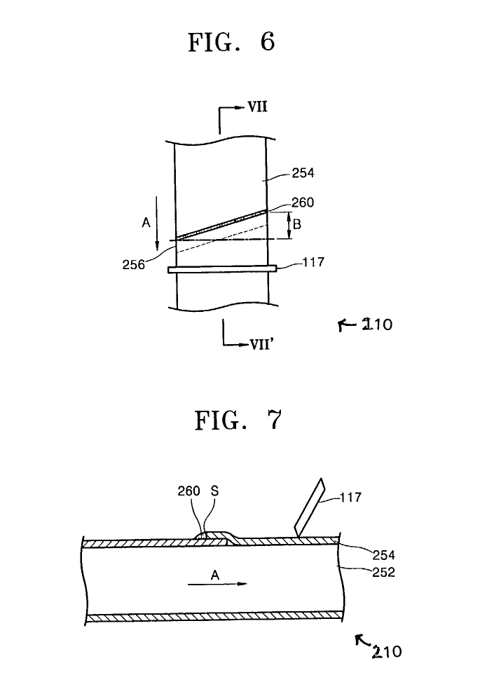

FIG. 6 is a plan view of a portion of the photosensitive drum 210 according to a second embodiment of the present invention. FIG. 7 is a cross-sectional view taken along line VII-VII′ of FIG. 6. Referring to FIGS. 6 and 7, a joint 256 is slanted at a predetermined angle with respect to a longitudinal direction of the photosensitive drum 210. Thus, point-contact occurs between the cleaning blade 117 and the joint 256. The slanted joint 256 prevents cutting of a photosensitive belt 254 due to shocks between the cleaning blade 117 and the joint 256. The slanted joint 256 also prevents movement of the belt 254 due to the shocks.

Also, an ultraviolet hardening adhesive is coated on the step S and exposed to ultraviolet rays, resulting in rapid hardening. A coating 260 obtained from this process allows the cleaning blade 117 to smoothly pass over the step S on the photosensitive drum 210 and prevents toner removed from the cleaning blade 117 from accumulating on the step S.

The ultraviolet hardening adhesive, which is used for coating the step S, is made by Loctite Corporation, has a product No. LI-504, and is characterized by table 1 below.

TABLE 1

| Usage | Low Viscosity |
|---|---|
| Hardening | UV (Aerotropism) |
| Primer | 7649 N |
| Surface Hardening Speed (100 mW/cm) | 5 sec |
| Tensile strength (kgf/m²) (Metal and Glass) | 220 |
| Viscosity (cp) | 1,000 |

The width B of the joint 256 being formed by both ends of the joint 256 in the rotary direction of the photosensitive drum 210 may be 1 mm or more.

When the photosensitive drum 210 having the structure of the second embodiment is used in the image forming apparatus, the point-contact between the cleaning blade 117 and the joint 256 and the coating 260 formed at the step S reduce shocks on the joint 256 so that the photosensitive drum 210 rotates smoothly. However, a toner image may be warped at the joint 256. Also, an area of the joint 256 is used as a non-image area on the photosensitive drum 210.

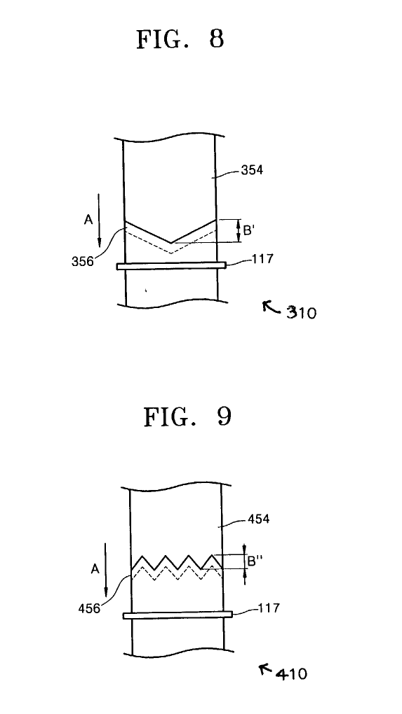

FIG. 8 is a plan view of a portion of a photosensitive drum 310 on which a joint 356 of a photosensitive belt 354 is formed according to a third embodiment of the present invention. Referring to FIG. 8, the joint 356 which contacts the cleaning blade 117 is slanted to both sides with respect to the center line of the photosensitive drum 310 in a rotary direction of the photosensitive drum 310 to form two point contacts. The width B′ of the joint 356 may be at least 1 mm or more on the circumference of the photosensitive drum 310.

FIG. 9 is a plan view of a portion of a photosensitive drum 410 on which a joint 456 of a photosensitive belt 454 is formed according to a fourth embodiment of the present invention. Referring to FIG. 9, the joint 456 which contacts the cleaning blade 117 forms a plurality of point contacts in a rotary direction of the photosensitive drum 410 to form a saw-tooth shape. The width B″ of the joint 456 may be at least 1 mm or more on the circumference of the photosensitive drum 410.

As described above, in a photosensitive drum structure for an image forming apparatus using a photosensitive belt according to the present invention, an inexpensive photosensitive belt is wound on a rotary drum. Thus, the photosensitive drum can be manufactured at a low cost. A joint contacts a cleaning blade at a point and a coating is formed to coat an exposed step of the joint to considerably reduce shocks between the joint and the cleaning blade. Also, the life of the photosensitive drum and the cleaning blade can be prolonged.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A photosensitive drum structure for an image forming apparatus, the photosensitive drum structure comprising:
a rotary drum;
a photosensitive belt wound on the rotary drum and attached thereto by an adhesive, the photosensitive belt having first and second ends; and
a joint formed on the rotary drum by overlapping the first and second ends of the photosensitive belt.

2. The photosensitive drum structure for an image forming apparatus of claim 1, wherein the joint includes an exposed step, and the apparatus further comprises:
a coating to cover the exposed step of the joint.

3. The photosensitive drum structure for an image forming apparatus of claim 2, wherein the coating is formed by exposing an ultraviolet hardening adhesive to ultraviolet rays.

4. The photosensitive drum structure for an image forming apparatus of claim 1, wherein the joint is formed at a non-image area on the photosensitive belt.

5. The photosensitive drum structure for an image forming apparatus of claim 1, further comprising a cleaning blade to contact the joint to form a point contact which is positioned along a longitudinal axis of the rotary drum.

6. The photosensitive drum structure for an image forming apparatus of claim 1, wherein the joint is maintained at a predetermined angle with respect to a longitudinal axis of the rotary drum.

7. A photosensitive drum structure for an image forming apparatus, the photosensitive drum structure comprising:
a rotary drum;
a joint formed on the rotary drum; and
a photosensitive belt wound on the rotary drum, comprising first and second ends which overlap to form the joint.

8. The photosensitive drum for an image forming apparatus of claim 7, wherein the photosensitive belt further comprises:
a base layer;
a conductive layer stacked on the base layer; and
a photosensitive layer stacked on the conductive layer.

9. The photosensitive drum for an image forming apparatus of claim 7, wherein the joint has a uniform width.

10. The photosensitive drum for an image forming apparatus of claim 7, wherein the first end is exposed and the second end is hidden.

11. The photosensitive drum structure for an image forming apparatus of claim 7, wherein the joint comprises a top portion and a step portion.

12. The photosensitive drum structure for an image forming apparatus of claim 11, wherein the cleaning blade first contacts the top portion and then contacts the step portion.

13. The photosensitive drum structure for an image forming apparatus of claim 7, wherein the joint is slanted to both sides with respect to a center line of the photosensitive drum.

14. The photosensitive drum structure for an image forming apparatus of claim 7, further comprising a cleaning blade to contact the joint to form three or more point contacts which are positioned along a longitudinal axis of the rotary drum.

15. The photosensitive drum structure for an image forming apparatus of claim 14, wherein the joint has a saw-tooth shape.

16. The photosensitive drum structure for an image forming apparatus of claim 7, wherein the joint is slanted with respect to a center line of the photosensitive drum.

17. An image forming apparatus, comprising:
photosensitive drum, comprising:
a rotary drum, and
a joint formed on the rotary drum; and
a developing unit to develop an image on the photosensitive drum.

18. The image forming apparatus of claim 17, wherein the photosensitive drum further comprises a photosensitive belt wound on the rotary drum, comprising first and second ends which overlap to form the joint.
